(19) United States
(12) Patent Application Publication
(10) Pub. No.: US 2024/0036392 A1
(43) Pub. Date: Feb. 1, 2024

(54) BACKLIGHT DRIVING CIRCUIT AND DISPLAY DEVICE

(71) Applicant: TCL CHINA STAR OPTOELECTRONICS TECHNOLOGY CO., LTD., Shenzhen, Guangdong (CN)

(72) Inventors: Jinfeng Liu, Shenzhen, Guangdong (CN); Youngil Ban, Shenzhen, Guangdong (CN); Jianfeng Xiao, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/622,781

(22) PCT Filed: Dec. 10, 2021
(86) PCT No.: PCT/CN2021/137119

§ 371 Date: Dec. 24, 2021

(30) Foreign Application Priority Data
Dec. 3, 2021 (CN) 202111464428.8

(51) Int. Cl. G02F 1/13357; G09G 3/34; G09G 3/32

(52) U.S. Cl. CPC G02F 1/133603; G09G 3/3406; G09G 3/32

(57) ABSTRACT

A backlight driving circuit and a display device are provided. The backlight driving circuit includes a light-emitting unit, a detection module, a power supply chip, and a voltage regulating module. The detection module receives a preset voltage and is electrically connected to a second electrode of the light-emitting unit to output a control voltage. The power supply chip is configured to output a reference voltage. The voltage regulating module receives the control voltage and the reference voltage, and is electrically connected to a first electrode of the light-emitting unit and a ground terminal to output a power supply voltage to the first electrode of the light-emitting unit.

### FIELD OF INVENTION

The present application relates to display technologies, and more particularly, to a backlight driving circuit and a display device.

### BACKGROUND OF INVENTION

Liquid crystal display (LCD) and organic light-emitting diode (OLED) are the current mainstream display technologies. OLED displays are widely used in electronic products such as mobile phones and TVs. In recent years, the industry has proposed a concept of Mini-LED display. As consumers have higher requirements for TV display quality, Mini-LED technology has received widespread attention.

A forward turn-on voltage Vf of the light-emitting diode (LED) is related to temperature. As shown in FIGS. 1 and 2, the higher the temperature, the less the forward turn-on voltage Vf of the LED. At this time, if a driving voltage received by the LED does not change, a voltage across the LED (forward voltage) increased will cause a current flowing through the LED increased rapidly. The currently backlight driving circuit usually controls the current flowing through the LED to be constant by setting a constant current source. However, the above-mentioned solution will cause part of electric energy not to be converted into light energy, which increases a power loss of the backlight driving circuit.

### SUMMARY OF INVENTION

The present application provides a backlight driving circuit and a display device to solve a technical problem of increasing a power loss of the backlight driving circuit by controlling a constant current through a constant current source in the prior art.

The present application provides a backlight driving circuit, including:
a light-emitting unit including a first electrode and a second electrode;
a detection module receiving a preset voltage and electrically connected to the second electrode, wherein the detection module is configured to output a control voltage according to an electrical potential of the second electrode and the voltage value of the preset voltage;
a power supply chip configured to output a reference voltage; and
a voltage regulating module receiving the control voltage and the reference voltage, and is electrically connected to the first electrode and a ground terminal, and wherein the voltage regulating module is configured to output a power supply voltage to the first electrode according to the control voltage and the reference voltage.

Optionally, in some embodiments of the present application, the detection module includes a comparison unit and a control unit;
the detection module includes a comparison unit and a control unit;
wherein a first input terminal of the comparison unit is electrically connected to the second electrode, a second input terminal of the comparison unit receives the preset voltage, and wherein the comparison unit is configured to output a detection signal according to an electrical potential of the second electrode and a voltage value of the preset voltage; and
wherein the control unit receives the detection signal, and wherein the control unit is configured to output the control voltage according to the detection signal.

Optionally, in some embodiments of the present application, the control unit includes a feedback logic assembly, a digital-to-analog converter, and an operational amplifier; and
wherein the feedback logic assembly is connected to the digital-to-analog converter, the feedback logic assembly receives the detection signal, and controls the digital-to-analog converter to output the control voltage according to the detection signal, and wherein the operational amplifier receives the control voltage and amplifies and outputs the control voltage.

Optionally, in some embodiments of the present application, the voltage regulating module includes a control transistor, a first resistor, a second resistor, a third resistor, a fourth resistor, and a fifth resistor;
wherein a gate electrode of the control transistor receives the control voltage, one of a source electrode and a drain electrode of the control transistor is connected to one terminal of the second resistor, and wherein another one of the source electrode and the drain electrode of the control transistor is connected to one terminal of the first resistor, and wherein another terminal of the first resistor is electrically connected to the ground terminal, and wherein another terminal of the second resistor, one terminal of the third resistor, and one terminal of the fourth resistor are connected together, and wherein another terminal of the third resistor is electrically connected to the first electrode, and wherein another terminal of the fourth resistor is connected to one terminal of the fifth resistor, and wherein another terminal of the fifth resistor is electrically connected to the ground terminal.

Optionally, in some embodiments of the present application, the control transistor is a voltage control type device.

Optionally, in some embodiments of the present application, the backlight driving circuit further includes an LED driving chip, and wherein the detection module, the first resistor, and the control transistor are integrated in the LED driving chip.

Optionally, in some embodiments of the present application, the backlight driving circuit further comprises a driving module, and wherein the driving module comprises a driving unit and a constant current control unit; wherein the driving unit receives a first control signal and is electrically connected to the second electrode and a first node, and the driving unit is configured to control a light-emitting duration of the light-emitting unit according to the first control signal; and wherein the constant current control unit receives a second control signal and is electrically connected to the ground terminal and the first node, and the constant current control unit is configured to control a current flow through the light-emitting device to be constant according to the second control signal.

Optionally, in some embodiments of the present application, the driving unit comprises a first transistor, a gate electrode of the first transistor receives the first control signal, and wherein one of a source electrode or a drain electrode of the first transistor is electrically connected to the second electrode, and the other of the source electrode and the drain electrode of the first transistor is electrically connected to the first node.

Optionally, in some embodiments of the present application, the constant current control unit comprises a second transistor and a sampling resistor;
wherein a gate electrode of the second transistor receives the second control signal, and wherein one of a source electrode and a drain electrode of the second transistor is electrically connected to the first node, and wherein another one of the source electrode and the drain electrode of the second transistor is connected to one terminal of the sampling resistor, and wherein another terminal of the sampling resistor is electrically connected to the ground terminal.

Correspondingly, the present application also provides a display device, which includes a display panel and a backlight module, wherein the backlight module is configured to provide a backlight source to the display panel, and wherein the backlight module comprises a backlight driving circuit comprising:
a light-emitting unit having a first electrode and a second electrode;
a detection module receiving a preset voltage and electrically connected to the second electrode, wherein the detection module is configured to output a control voltage according to an electrical potential of the second electrode and the voltage value of the preset voltage;
a power supply chip configured to output a reference voltage; and
a voltage regulating module receiving the control voltage and the reference voltage, and is electrically connected to the first electrode and a ground terminal, and wherein the voltage regulating module is configured to output a power supply voltage to the first electrode according to the control voltage and the reference voltage.

Optionally, in some embodiments of the present application, the detection module comprises a comparison unit and a control unit;
wherein a first input terminal of the comparison unit is electrically connected to the second electrode, a second input terminal of the comparison unit receives the preset voltage, and wherein the comparison unit is configured to output a detection signal according to an electrical potential of the second electrode and a voltage value of the preset voltage; and
wherein the control unit receives the detection signal, and wherein the control unit is configured to output the control voltage according to the detection signal.

Optionally, in some embodiments of the present application, the control unit comprises a feedback logic assembly, a digital-to-analog converter, and an operational amplifier; and
wherein the feedback logic assembly is connected to the digital-to-analog converter, the feedback logic assembly receives the detection signal, and controls the digital-to-analog converter to output the control voltage according to the detection signal, and wherein the operational amplifier receives the control voltage and amplifies and outputs the control voltage.

Optionally, in some embodiments of the present application, the voltage regulating module comprises a control transistor, a first resistor, a second resistor, a third resistor, a fourth resistor, and a fifth resistor; and
wherein a gate electrode of the control transistor receives the control voltage, one of a source electrode and a drain electrode of the control transistor is connected to one terminal of the second resistor, and wherein another one of the source electrode and the drain electrode of the control transistor is connected to one terminal of the first resistor, and wherein another terminal of the first resistor is electrically connected to the ground terminal, another terminal of the second resistor, and wherein another terminal of the second resistor, one terminal of the third resistor, and one terminal of the fourth resistor are connected together, and wherein another terminal of the third resistor is electrically connected to the first electrode, and wherein another terminal of the fourth resistor is connected to one terminal of the fifth resistor, and wherein another terminal of the fifth resistor is electrically connected to the ground terminal.

Optionally, in some embodiments of the present application, the control transistor is a voltage control type device.

Optionally, in some embodiments of the present application, the backlight driving circuit further includes an LED driving chip, and wherein the detection module, the first resistor, and the control transistor are integrated in the LED driving chip.

Optionally, in some embodiments of the present application, the backlight driving circuit further comprises a driving module, and wherein the driving module comprises a driving unit and a constant current control unit;
wherein the driving unit receives a first control signal and is electrically connected to the second electrode and a first node, and the driving unit is configured to control a light-emitting duration of the light-emitting unit according to the first control signal; and
wherein the constant current control unit receives a second control signal and is electrically connected to the ground terminal and the first node, and the constant current control unit is configured to control a current flow through the light-emitting device to be constant according to the second control signal.

Optionally, in some embodiments of the present application, the driving unit includes a first transistor, the gate of the first transistor is connected to the first control signal, and the source and drain of the first transistor are connected to One of is electrically connected to the second electrode, and the other of the source and drain of the first transistor is electrically connected to the first node.

Optionally, in some embodiments of the present application, the constant current control unit comprises a second transistor and a sampling resistor; and
wherein a gate electrode of the second transistor receives the second control signal, and wherein one of a source electrode and a drain electrode of the second transistor is electrically connected to the first node, and wherein another one of the source electrode and the drain electrode of the second transistor is connected to one terminal of the sampling resistor, and wherein another terminal of the sampling resistor is electrically connected to the ground terminal

The present application provides a backlight driving circuit and a display device. The backlight driving circuit includes a light-emitting unit, a detection module, a power supply chip, and a voltage regulating module. In the backlight driving circuit of the present application, a detection module is configured to detect an electrical potential of a second electrode of the light-emitting unit. Then, according to the electrical potential of the second electrode of the light-emitting unit and a preset voltage, an offset of a forward turn-on voltage of the light-emitting unit can be determined, and the control voltage can be output accordingly. The voltage regulating module can output a power supply voltage to a first electrode of the light-emitting unit according to a control of the control voltage and the reference voltage, to realize a voltage value adjustment of the power supply voltage. Therefore, while avoiding a rapid increase of the current flowing through the light-emitting unit, a power loss of the backlight driving circuit is reduced, and an energy efficiency performance of the backlight driving circuit is improved. In addition, since the power loss is reduced, a temperature of the backlight driving circuit can be reduced.

### DESCRIPTION OF FIGURES

In order to explain the technical solutions in the embodiments of the present application more clearly, the following will briefly introduce the figures needed in the description of the embodiments. Obviously, the figures in the following description are only some embodiments of the present application. For those skilled in the art, without inventive steps, other figures can be obtained based on these figures.

FIG. 1 is a schematic diagram of a relationship between a forward turn-on voltage and a temperature of the LED provided in the present application.

FIG. 2 is a schematic diagram of a relationship between a forward current and a forward voltage of the LED provided in the present application.

FIG. 3 is a schematic diagram of a structure of a backlight driving circuit provided by the present application.

FIG. 4 is a schematic diagram of a structure of a detection module provided by the present application.

FIG. 5 is a schematic diagram of a first circuit of the backlight driving circuit provided by the present application.

FIG. 6 is a schematic diagram of a second circuit of the backlight driving circuit provided by the present application.

FIG. 7 is a schematic diagram of a structure of a display device provided by the present application.

### DETAILED DESCRIPTION OF EMBODIMENTS

The technical solutions in the embodiments of the present application will be clearly and completely described below in conjunction with the figures in the embodiments of the present application. Obviously, the described embodiments are only a part of the embodiments of the present application, rather than all the embodiments. Based on the embodiments in the present application, all other embodiments obtained by those skilled in the art without inventive steps shall fall within a protection scope of the present application.

In the description of the present application, it should be understood that a terms “first” and “second” are only used for descriptive purposes, and cannot be understood as indicating or implying relative importance or implicitly indicating the number of indicated technical features. Therefore, the features defined as “first” and “second” may explicitly or implicitly include one or more of the features, and therefore cannot be understood as a limitation of the present application.

The present application provides a backlight driving circuit and a display device, which will be described in detail below. It should be noted that a description order of the following embodiments is not intended to limit a preferred order of the embodiments of the present application.

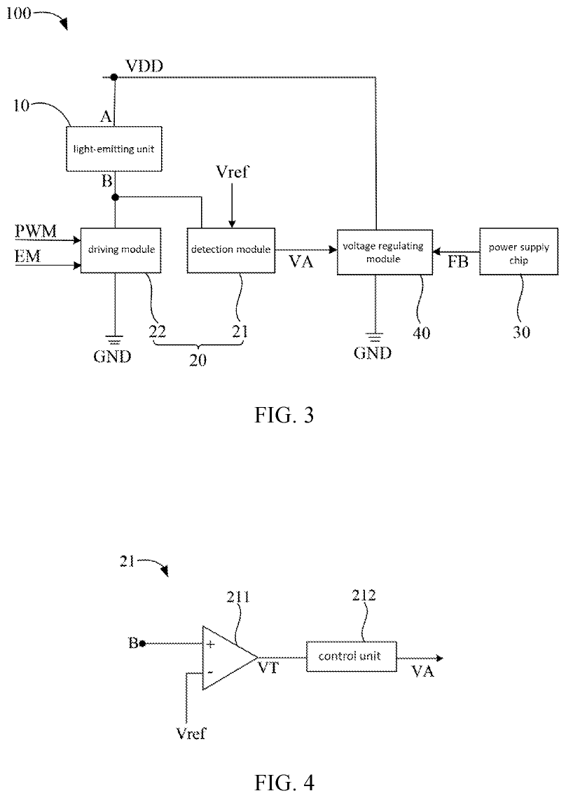

Please refer to FIG. 3, which is a schematic structural diagram of the backlight driving circuit provided by the present application. In the present application, the backlight driving circuit 100 includes a light-emitting unit 10, a detection module 21, a power supply chip 30, and a voltage regulating module 40.

The light-emitting unit 10 includes a first electrode A and a second electrode B. The detection module 21 receives a preset voltage Vref, and is electrically connected to the second electrode B. The detection module 21 is configured to output a control voltage VA according to an electrical potential of the second electrode B and the voltage value of the preset voltage Vref. The power supply chip 30 is configured to output a reference voltage FB. The voltage regulating module 40 receives the control voltage VA and the reference voltage FB, and is electrically connected to the first electrode A and a ground terminal GND. The voltage regulating module 40 is configured to output a power supply voltage VDD to the first electrode A according to the control voltage VA and the reference voltage FB. The current flows through the first electrode A of the light-emitting unit 10 to the second electrode B of the light-emitting unit 10.

In the backlight driving circuit 100 of the present application, the detection module 21 is provided to detect the electrical potential of the second electrode B of the light-emitting unit 10. It can be understood that when the temperature rises, a forward turn-on voltage of the light-emitting unit 10 becomes less. At the same time, if the power supply voltage VDD unchanged, an electrical potential of the second electrode B will be increased. Therefore, an offset of the forward turn-on voltage of the light-emitting unit 10 can be determined according to the electrical potential of the second electrode B of the light-emitting unit 10 and the preset voltage Vref. Then, the control voltage VA is output according to the offset of the forward turn-on voltage of the light-emitting unit 10. Next, the voltage regulating module 40 outputs the power supply voltage VDD according to the control voltage VA and the reference voltage FB. Since the offsets of the forward turn-on voltage of the light-emitting units 10 are different, and the control voltages VA have different voltage values, a voltage value of the power supply voltage VDD can be adjusted. Therefore, a power loss of the backlight driving circuit 100 can be reduced while avoiding the rapid increase of the current flowing through the light-emitting unit 10, and an energy efficiency performance of the backlight driving circuit 100 can be improved. In addition, since the power loss is reduced, the temperature of the backlight driving circuit 100 can be reduced.

In the present application, the light-emitting unit 10 may include at least one light-emitting device. The light-emitting device can be a mini light-emitting diode, a micro light-emitting diode or an organic light-emitting diode. When the light-emitting device is the aforementioned light-emitting diode, the first electrode A of the light-emitting unit 10 may be an anode of the light-emitting device, and the second electrode B of the light-emitting unit 10 may be a cathode of the light-emitting device. When the light-emitting unit 10 includes more than two light-emitting devices, the plurality of light-emitting devices D may be arranged in series or in parallel, which is not specifically limited in the present application.

In the present application, the power supply chip 30 is a direct current power converter (DC-DC). The reference voltage FB is a voltage regulation reference value of the power supply chip 30 and is determined by the internal current source. A voltage value of the reference voltage FB is a fixed value, usually 0.6V or 0.8V, etc., which can be set according to actual requirements.

In the present application, the preset voltage Vref can be set by a register (not shown in the figure) that controls this function. A voltage value of the preset voltage Vref is greater than or equal to an electrical potential of the second electrode B at an initial stage. In the initial stage, the electrical potential of the second electrode B refers to the electrical potential of the second electrode B when the forward turn-on voltage of the light-emitting unit 10 does not drift. The voltage value of the preset voltage Vref can have different levels. In the present application, the less the voltage value of the preset voltage Vref, the more obvious the effect of reducing power consumption. However, an open-circuit detection module (not shown in the figure) is usually provided in the backlight driving circuit 100. If the voltage value of the preset voltage Vref is too less, it may cause false detection of the open circuit, so the preset voltage Vref is generally 0.4V.

In the present application, the backlight driving circuit 100 further includes an LED driving chip 20. The detection module 21 is integrated in the LED driving chip 20. In the present application, by integrating the detection module 21 in the LED driving chip 20, a circuit structure of the backlight driving circuit 100 can be simplified.

Please refer to FIG. 4, FIG. 4 is a schematic diagram of a structure of a detection module provided by the present application. With reference to FIG. 3 and FIG. 4, in some embodiments of the present application, the detection module 21 includes a comparison unit 211 and a control unit 212. A first input terminal of the comparison unit 211 is electrically connected to the second electrode B to receive an electrical potential of the second electrode B of the light-emitting unit 10. A second input terminal of the comparison unit 211 receives the preset voltage Vref. The comparison unit 211 is configured to output a detection signal VT according to an electrical potential of the second electrode B and the voltage value of the preset voltage Vref. The control unit 212 receives the detection signal VT. The control unit 212 is configured to adjust the voltage value of the control voltage VA according to the detection signal VT.

The comparison unit 211 may be a comparator. The detection signal VT may be a voltage difference between the electrical potential of the second electrode B and the voltage value of the preset voltage Vref. Since the voltage value of the preset voltage Vref has been set in advance, the electrical potential of the second electrode B can be determined by the detection signal VT, thereby determining a degree of deviation of the forward turn-on voltage of the light-emitting unit 10. The control unit 212 may adjust the voltage value of the control voltage VA according to the detection signal VT, to subsequently adjust the voltage value of the power supply voltage VDD.

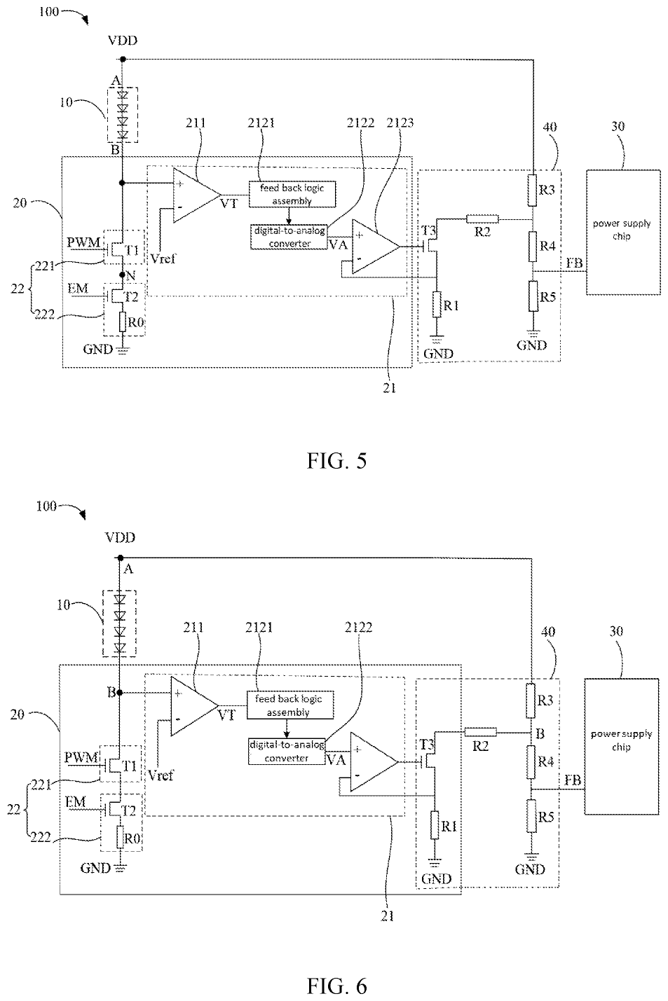

Please refer to FIG. 5. FIG. 5 is a schematic diagram of a first circuit of the backlight driving circuit provided by the present application. In this embodiment of the present application, the control unit 212 includes a feedback logic assembly 2121, a digital-to-analog converter 2122, and an operational amplifier 2123. The feedback logic assembly 2121 is connected to the digital-to-analog converter 2122. The feedback logic assembly 2121 receives the detection signal VT, and controls the digital-to-analog converter 2122 to output the control voltage VA according to the detection signal VT. The operational amplifier 2123 receives the control voltage VA, and amplifies and outputs the control voltage VA.

The feedback logic assembly 2121 is equivalent to a command unit, which can control the digital-to-analog converter 2122 to output a control voltage VA with a corresponding voltage value according to different detection signals VT The components of the digital-to-analog converter 2122 well known to those skilled in the art will not be repeated here. The control voltage VA is an analog signal output by the digital-to-analog converter 2122.

A non-inverting input terminal of the operational amplifier 2123 receives the control voltage VA. An inverting input terminal of the operational amplifier 2123 receives a reference voltage, which only needs to meet the normal functional requirements of the operational amplifier 2123, and no specific setting is made here. The operational amplifier 2123 amplifies the control voltage VA, which can enhance a driving ability of the control voltage VA and facilitate a normal operation of the driving load.

Further, in some embodiments of the present application, the voltage regulating module 40 includes a control transistor T3, a first resistor R1, a second resistor R2, a third resistor R3, a fourth resistor R4, and a fifth resistor R5.

The gate electrode of the control transistor T3 receives the control voltage VA. One of a source electrode and a drain electrode of the control transistor T3 is connected to one terminal of the second resistor R2. Another one of the source electrode and the drain electrode of the control transistor T3 is connected to one terminal of the first resistor R1. Another terminal of the first resistor R1 is electrically connected to the ground terminal GND. Another terminal of the second resistor R2 is connected to one terminal of the third resistor R3 and one terminal of the fourth resistor R4. Another terminal of the third resistor R3 is electrically connected to the output terminal M of the power supply voltage VDD. Another terminal of the fourth resistor R4 is connected to one terminal of the fifth resistor R5. Another terminal of the fifth resistor R5 is electrically connected to the ground terminal GND.

The control transistor T3 is a voltage-controlled device. For example, the control transistor T3 is a metal-oxide-semiconductor field-effect transistor (MOSFET). A magnitude of the drain current of the control transistor T3 is controlled by the voltage between the gate electrode and the source electrode. When different gate voltages are applied to the gate electrode of the control transistor T3, a resistance partial pressure of the resistors R1 to R5 can be changed to achieve a purpose of adjusting the voltage value of the power supply voltage VDD.

Specifically, when the forward turn-on voltage of the light-emitting unit 10 does not drift, that is, the electrical potential of the second electrode B is less than the preset voltage Vref, the detection module 21 does not output the control voltage VA. At this time, the control transistor T3 is turned off. In the voltage regulating module 40, only the third resistor R3, the fourth resistor R4, and the fifth resistor R5 participate in the work. The voltage value of the power supply voltage VDD is: VDD=V_{FB}(R3+R4+R5)/R5. Therefore, the voltage value of the power supply voltage VDD can be controlled by adjusting the ratio of the three resistors of the third resistor R3, the fourth resistor R4, and the fifth resistor R5.

When the temperature rises, the forward turn-on voltage of the light-emitting unit 10 becomes less. That is, when the electrical potential of the second electrode B is greater than the preset voltage Vref, the detection module 21 outputs the control voltage VA. The control transistor T3 is turned on. At this time, a resistance formed by the series connection of the first resistor R1, the control transistor T3, and the second resistor R2 is: R=R2+R_{T3}+R1. The voltage value of the power supply voltage VDD at this time is: VDD=V_{FB}[R3(R4+R5)/R+R3+R4+R5]/R5. It can be seen that the corresponding relationship between the resistance value R_{T3} of the control transistor T3 and the voltage value of the power supply voltage VDD is: The more a resistance value of the R_{T3}, the less the voltage value of the power supply voltage of the VDD. The opposite is the same. Therefore, under a condition that the resistance value of the other resistance remains unchanged, an equivalent resistance of the control transistor T3 can be changed by adjusting the gate-source voltage of the control transistor T3, thereby adjusting the voltage value of the power supply voltage VDD. For example, the higher the electrical potential of the second electrode B, the lower the forward turn-on voltage of the light-emitting unit 10 is. At this time, the voltage value of the control voltage VA output by the digital-to-analog converter 2122 is reduced, thereby increasing the equivalent resistance of the control transistor T3 and reducing the voltage value of the power supply voltage VDD. The decrease in the voltage value of the power supply voltage VDD reduces the electrical potential of the second electrode B, thereby reducing power consumption.

The transistors used in the embodiments of the present application may include P-type transistors and/or N-type transistors. The P-type transistor is turned on when the gate electrode is at a low electrical potential, and is turned off when the gate electrode is at a high electrical potential. The N-type transistor is turned on when the gate electrode is at a high electrical potential, and turned off when the gate electrode is at a low electrical potential. Since the source electrode and the drain electrode of the transistor used here are symmetrical, the source electrode and the drain electrode are interchangeable. In the present application, in order to distinguish the two electrodes of the transistor other than the gate electrode, one of the electrodes is called the source electrode and another electrode is called the drain electrode. According to the form in the figure, it is stipulated that a middle terminal of the switching transistor is the gate electrode, a signal input terminal is the source electrode, and a signal output terminal is the drain electrode. It should be noted that the transistors in the embodiments of the present application are all described by taking an N-type transistor as an example, but it should not be understood as a limitation of the present application.

In some embodiments of the present application, the non-inverting input terminal of the operational amplifier 2123 receives the control voltage VA. The inverting input terminal of the operational amplifier 2123 is connected to the another one of the source electrode and the drain electrode of the control transistor T3 and one terminal of the first resistor R1. That is, the reference voltage connected to the inverting input terminal of the operational amplifier 2123 is the ground voltage on the first resistor R1.

Please continue to refer to FIGS. 3 and 5. In this embodiment of the present application, the backlight driving circuit 100 further includes a driving module 22. The driving module 22 includes a driving unit 221 and a constant current control unit 222.

The driving unit 221 receives a first control signal PWM, and is electrically connected to the second electrode B and the first node N. The driving unit 221 is configured to control a light-emitting duration of the light-emitting unit 10 according to the first control signal PWM. Specifically, pulse width modulation may be used to adjust the duty cycle of the first control signal PWM, to control the light-emitting duration of the light-emitting unit 10.

The constant current control unit 222 is connected to the second control signal EM and is electrically connected to the ground terminal GND and the first node N. The constant current control unit 222 is configured to control the current flowing through the light-emitting unit 10 to be constant according to the second control signal EM. Specifically, a voltage amplitude of the second control signal EM can be adjusted by pulse amplitude modulation to ensure that the current flowing through the second transistor T2 to be constant.

Specifically, in some embodiments of the present application, the driving unit 221 includes a first transistor T1. The gate electrode of the first transistor T1 is connected to the first control signal PWM. One of the source electrode and drain electrode of the first transistor T1 is electrically connected to the second electrode B. The another one of the source electrode and the drain electrode of the first transistor T1 is electrically connected to the first node N. Of course, it can be understood that the driving unit 221 may also be composed of a plurality of transistors connected in series.

In some embodiments of the present application, the constant current control unit 222 includes a second transistor T2 and a sampling resistor R0. A gate electrode of the second transistor T2 receives the second control signal EM. One of a source electrode and a drain electrode of the second transistor T2 is electrically connected to the first node N. Another one of the source electrode and the drain electrode of the second transistor T2 is connected to one terminal of the sampling resistor R0. Another terminal of the sampling resistor R0 is electrically connected to the ground terminal GND.

By detecting a ground voltage of the sampling resistor R0, the current flowing through the light-emitting unit 10 can be confirmed. Then, the constant current control is ensured by controlling the gate-source voltage on the second transistor T2.

In the embodiment of the present application, the driving module 22 is also integrated in the LED driving chip 20. It can be understood that when a temperature rises, the forward turn-on voltage of the light-emitting unit 10 decreased, and the current flowing through the light-emitting unit 10 increased rapidly. By detecting the ground voltage of the sampling resistor R0, when an increase in current is detected, the voltage value of the second control voltage EM can be reduced to reduce the current flowing through the light-emitting unit 10 and keep the current constant. However, at this time, part of the electric energy in the LED driving chip 20 cannot be converted into light energy, and thus converted into heat energy in the LED driving chip 20, which causes the LED driving chip 20 to heat up too high. The present application reduces the voltage value of the power supply voltage VDD, which can reduce the electrical potential of the second electrode B of the light-emitting unit 10, thereby reducing the electrical potential of the second electrode B to the ground. That is, the voltage drop inside the LED driving chip 20 is reduced. Therefore, a power consumption in the LED driving chip 20 is reduced and the temperature of the LED driving chip 20 is prevented from being too high.

In the embodiment of the present application, the voltage regulating module 40 is disposed outside the LED driving chip 20. It can be understood that, since the resistance values of the first resistor R1, the second resistor R2, the control transistor T3, the third resistor R3, the fourth resistor R4, and the fifth resistor R5 are different in the voltage regulating module 40, the voltage value of the output power supply voltage VDD will also be different. Different backlight driving circuits 100 may require different power supply voltages VDD. Therefore, the voltage regulating module 40 is disposed outside the LED driving chip 20, and the LED driving chip 20 can be used in common among backlight driving circuits 100 of different specifications.

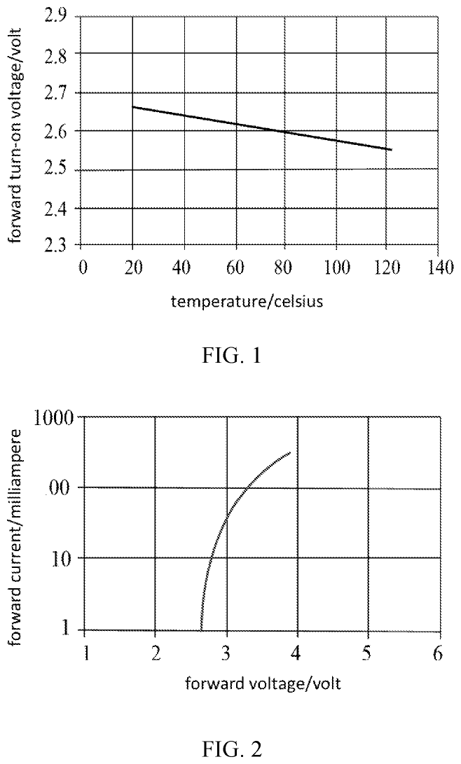

Please refer to FIG. 6. FIG. 6 is a schematic diagram of a second circuit of the backlight driving circuit provided by the present application. A difference from the backlight driving circuit 100 shown in FIG. 1 is that in this embodiment, the detection module 21, the driving module 22, the control transistor T3 and the first resistor R1 are all integrated in the LED driving chip 20.

It can be understood that, in this embodiment, the control transistor T3 is provided in the LED driving chip 20, and the control transistor T3 can be made by the same process as the first transistor T1 and the second transistor T2. The second resistor R2, the third resistor R3, the fourth resistor R4, and the fifth resistor R5 can all be obtained by patterning a metal layer. Therefore, the manufacturing process of the backlight driving circuit 100 can be simplified.

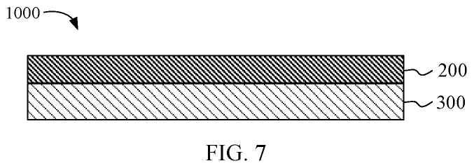

Correspondingly, the present application also provides a display device. Specifically, please refer to FIG. 7. FIG. 7 is a schematic structural diagram of a structure of the display device provided by the present application. The display device 1000 includes a display panel 200 and a backlight module 300. The backlight module 300 is configured to provide a backlight source to the display panel 200. The backlight module 300 includes a backlight driving circuit (not shown in the figure) as described in any of the above embodiments. For details, please refer to the above content, which will not be repeated here.

In the present application, the display device may be a smart phone, a tablet computer, a video player, a personal computer (PC), etc., which is not limited in the present application.

In the display device 1000 provided in the present application, the backlight module 300 includes a backlight driving circuit. The backlight drive circuit is provided with a detection module and a voltage regulation module. The detection module detects an electrical potential of a second electrode of the light-emitting unit, and can determine an offset of the forward turn-on voltage of the light-emitting unit. Then, the control voltage VA is output according to the offset amount of the forward turn-on voltage of the light-emitting unit. The voltage regulating module can adjust the voltage value of the power supply voltage under a control of the control voltage, thereby avoiding a rapid increase of the current flowing through the light-emitting unit, reducing a power loss of the backlight driving circuit, and improving an overall quality of the display device 1000.

The embodiments of the application are described in detail above, and specific examples are used in this article to illustrate the principles and implementation of the present application. The descriptions of the above examples are only used to help understand the methods and core ideas of the present application. At the same time, for those of ordinary skill in the art, based on the ideas of the present application, there will be changed in the specific implementation and the scope of application. In summary, the content of this specification should not be construed as a limitation to the present application.

What is claimed is:

1. A backlight driving circuit, comprising:
a light-emitting unit comprising a first electrode and a second electrode;
a detection module receiving a preset voltage and electrically connected to the second electrode, wherein the detection module is configured to output a control voltage according to an electrical potential of the second electrode and a voltage value of the preset voltage;
a power supply chip configured to output a reference voltage; and
a voltage regulating module receiving the control voltage and the reference voltage, and electrically connected to the first electrode and a ground terminal, and wherein the voltage regulating module is configured to output a power supply voltage to the first electrode according to the control voltage and the reference voltage.

2. The backlight driving circuit according to claim 1, wherein the detection module comprises a comparison unit and a control unit;
wherein a first input terminal of the comparison unit is electrically connected to the second electrode, a second input terminal of the comparison unit receives the preset voltage, and wherein the comparison unit is configured to output a detection signal according to the electrical potential of the second electrode and the voltage value of the preset voltage; and
wherein the control unit receives the detection signal, and wherein the control unit is configured to output the control voltage according to the detection signal.

3. The backlight driving circuit according to claim 2, wherein the control unit comprises a feedback logic assembly, a digital-to-analog converter, and an operational amplifier; and
wherein the feedback logic assembly is connected to the digital-to-analog converter, the feedback logic assembly receives the detection signal, and controls the digital-to-analog converter to output the control voltage according to the detection signal, and wherein the operational amplifier receives the control voltage and amplifies and outputs the control voltage.

4. The backlight driving circuit according to claim 1, wherein the voltage regulating module comprises a control transistor, a first resistor, a second resistor, a third resistor, a fourth resistor, and a fifth resistor;
wherein a gate electrode of the control transistor receives the control voltage, one of a source electrode and a drain electrode of the control transistor is connected to one terminal of the second resistor, and wherein another one of the source electrode and the drain electrode of the control transistor is connected to one terminal of the first resistor, and wherein another terminal of the first resistor is electrically connected to the ground terminal, and wherein another terminal of the second resistor, one terminal of the third resistor, and one terminal of the fourth resistor are connected together, and wherein another terminal of the third resistor is electrically connected to the first electrode, and wherein another terminal of the fourth resistor is connected to one terminal of the fifth resistor, and wherein another terminal of the fifth resistor is electrically connected to the ground terminal.

5. The backlight driving circuit according to claim 4, wherein the control transistor is a voltage control type device.

6. The backlight driving circuit according to claim 4, wherein the backlight driving circuit further comprises an LED driving chip, and wherein the detection module, the first resistor, and the control transistor are integrated in the LED driving chip.

7. The backlight driving circuit according to claim 1, wherein the backlight driving circuit further comprises a driving module, and wherein the driving module comprises a driving unit and a constant current control unit;
wherein the driving unit receives a first control signal and is electrically connected to the second electrode and a first node, and wherein the driving unit is configured to control a light-emitting duration of the light-emitting unit according to the first control signal; and
wherein the constant current control unit receives a second control signal and is electrically connected to the ground terminal and the first node, and wherein the constant current control unit is configured to control a current flow through the light-emitting device to be constant according to the second control signal.

8. The backlight driving circuit according to claim 7, wherein the driving unit is configured to control a light-emitting duration of the light-emitting unit according to a duty cycle of the first control signal, and wherein the constant current control unit is configured to control the current flow through the light-emitting device to be constant according to a voltage amplitude value of the second control signal.

9. The backlight driving circuit according to claim 7, wherein the driving unit comprises a first transistor, a gate electrode of the first transistor receives the first control signal, and wherein one of a source electrode or a drain electrode of the first transistor is electrically connected to the second electrode, and wherein another of the source electrode and the drain electrode of the first transistor is electrically connected to the first node.

10. The backlight driving circuit according to claim 7, wherein the constant current control unit comprises a second transistor and a sampling resistor;
wherein a gate electrode of the second transistor receives the second control signal, and wherein one of a source electrode and a drain electrode of the second transistor is electrically connected to the first node, and wherein another one of the source electrode and the drain electrode of the second transistor is connected to one terminal of the sampling resistor, and wherein another terminal of the sampling resistor is electrically connected to the ground terminal.

11. The backlight driving circuit according to claim 1, wherein the light-emitting unit comprises at least one light-emitting device, and wherein the light-emitting device is one of a mini-light-emitting diode, a micro-light-emitting diode, or an organic light-emitting diode.

12. A display device comprising a display panel and a backlight module, wherein the backlight module is configured to provide a backlight source to the display panel, and wherein the backlight module comprises a backlight driving circuit comprising:
a light-emitting unit having a first electrode and a second electrode;
a detection module receiving a preset voltage and electrically connected to the second electrode, wherein the detection module is configured to output a control voltage according to an electrical potential of the second electrode and a voltage value of the preset voltage;
a power supply chip configured to output a reference voltage; and
a voltage regulating module receiving the control voltage and the reference voltage, and electrically connected to the first electrode and a ground terminal, and wherein the voltage regulating module is configured to output a power supply voltage to the first electrode according to the control voltage and the reference voltage.

13. The display device according to claim 12, wherein the detection module comprises a comparison unit and a control unit;
wherein a first input terminal of the comparison unit is electrically connected to the second electrode, a second input terminal of the comparison unit receives the preset voltage, and wherein the comparison unit is configured to output a detection signal according to the electrical potential of the second electrode and the voltage value of the preset voltage; and
wherein the control unit receives the detection signal, and wherein the control unit is configured to output the control voltage according to the detection signal.

14. The display device according to claim 13, wherein the control unit comprises a feedback logic assembly, a digital-to-analog converter, and an operational amplifier; and
wherein the feedback logic assembly is connected to the digital-to-analog converter, the feedback logic assembly receives the detection signal, and controls the digital-to-analog converter to output the control voltage according to the detection signal, and wherein the operational amplifier receives the control voltage and amplifies and outputs the control voltage.

15. The display device according to claim 12, wherein the voltage regulating module comprises a control transistor, a first resistor, a second resistor, a third resistor, a fourth resistor, and a fifth resistor; and
wherein a gate electrode of the control transistor receives the control voltage, one of a source electrode and a drain electrode of the control transistor is connected to one terminal of the second resistor, and wherein another one of the source electrode and the drain electrode of the control transistor is connected to one terminal of the first resistor, and wherein another terminal of the first resistor is electrically connected to the ground terminal, another terminal of the second resistor, and wherein another terminal of the second resistor, one terminal of the third resistor, and one terminal of the fourth resistor are connected together, and wherein another terminal of the third resistor is electrically connected to the first electrode, and wherein another terminal of the fourth resistor is connected to one terminal of the fifth resistor, and wherein another terminal of the fifth resistor is electrically connected to the ground terminal.

16. The display device according to claim 15, wherein the control transistor is a voltage control type device.

17. The display device according to claim 15, wherein the backlight driving circuit further comprises an LED driving chip, and wherein the detection module, the first resistor, and the control transistor are integrated in the LED driving chip.

18. The display device according to claim 1, wherein the backlight driving circuit further comprises a driving module, and wherein the driving module comprises a driving unit and a constant current control unit;
wherein the driving unit receives a first control signal and is electrically connected to the second electrode and a first node, and wherein the driving unit is configured to control a light-emitting duration of the light-emitting unit according to the first control signal; and
wherein the constant current control unit receives a second control signal and is electrically connected to the ground terminal and the first node, and wherein the constant current control unit is configured to control a current flow through the light-emitting device to be constant according to the second control signal.

19. The display device according to claim 18, wherein the driving unit comprises a first transistor, a gate electrode of the first transistor receives the first control signal, and wherein one of a source electrode or a drain electrode of the first transistor is electrically connected to the second electrode, and wherein another of the source electrode and the drain electrode of the first transistor is electrically connected to the first node.

20. The display device according to claim 18, wherein the constant current control unit comprises a second transistor and a sampling resistor; and
wherein a gate electrode of the second transistor receives the second control signal, and wherein one of a source electrode and a drain electrode of the second transistor is electrically connected to the first node, and wherein another one of the source electrode and the drain electrode of the second transistor is connected to one terminal of the sampling resistor, and wherein another terminal of the sampling resistor is electrically connected to the ground terminal.
